(19) United States
(12) Patent Application Publication
(10) Pub. No.: US 2023/0407754 A1
(43) Pub. Date: Dec. 21, 2023

(54) COMPOSITE VANE FOR AN AIRCRAFT TURBOMACHINE AND METHOD FOR THE MANUFACTURE THEREOF

(71) Applicant: SAFRAN AIRCRAFT ENGINES, Paris (FR)

(72) Inventors: Vincent Marie Jacques Remi DE CARNE-CARNAVALET, Moissy-Cramayel (FR); Pierre Gregoire ANTON, Moissy-Cramayel (FR); Celia IGLESIAS CANO, Moissy-Cramayel (FR)

(21) Appl. No.: 18/252,162

(22) PCT Filed: Nov. 15, 2021
(86) PCT No.: PCT/FR2021/052006

§ 371 Date: May 8, 2023

(30) Foreign Application Priority Data
Nov. 23, 2020 (FR) FR2011994

(51) Int. Cl. F01D 5/28; F01D 9/04; B29C 70/46

(52) U.S. Cl. CPC F01D 5/282; F01D 9/041; B29C 70/46; F05D 2300/6012; F05D 2300/2102; F05D 2240/12; F05D 2300/6034; F05D 2300/224; F05D 2230/20; B29L 2031/082

(57) ABSTRACT

A composite vane for a turbomachine, in particular an aircraft turbomachine, this vane including an aerofoil having a pressure side and a suction side connected together by a leading edge and by a trailing edge, the aerofoil been formed from a fibrous preform obtained by weaving fibres in three dimensions, which is embedded in a polymer matrix, the vane further including a first metal shield extending over and along the leading edge of the aerofoil, the vane further including at least one cover element extending over and along the trailing edge of the aerofoil.

### TECHNICAL FIELD OF THE INVENTION

The present invention relates to a composite material vane for an aircraft turbomachine, as well as to a method for manufacturing this vane.

### TECHNICAL BACKGROUND

The prior art comprises in particular the documents FR-A1-2 956 057, FR-A1-3 029 134, FR-A1-3 049 002, FR-A1-3 076 851, EP-A1-2 843 192, FR-A1-3 012 515 and FR-A1-3 051386.

The use of composite materials is advantageous in the aeronautical industry in particular because these materials have interesting mechanical performances for relatively low masses.

One method for manufacturing a composite part for the aeronautical industry, which is well known to the person skilled in the art, is the moulding method RTM, the initials of which refer to the acronym Resin Transfer Molding.

This is a method for making a part from a composite material based on woven fibres and resin. Such a method is used, for example, to manufacture a turbomachine vane. The woven fibres may be in the form of plies or layers which are draped over each other, or may be in the form of a preform obtained by weaving fibres in three dimensions. The present invention relates more particularly to the manufacture of a vane from such a preform.

The resulting fibrous preform is placed in a thermocompression mould. If the woven fibres are not previously impregnated with resin, a resin is injected into this mould. This preform is then heated to polymerise the resin and form the final part, for example a blade of vane. This blade comprises a pressure side and a suction side that extend from a leading edge to a trailing edge of the blade.

The composite material of the blade is relatively fragile, and in particular sensitive to shocks, and it is known to protect it by means of a metal shield which is fitted and attached on the leading edge of the blade. This shield can be glued after the resin has polymerised or co-injected into the mould as the preform is cycling through the polymerisation. It allows to protect the leading edge from erosion but also improves the strength of the vane against the ingestions (hail, gravel, debris, birds, etc.).

The three-dimensional woven preform is designed with dead areas around the edges to ensure that, following the removal of these dead areas, the required mechanical and spatial specifications are achieved. The preform is therefore woven wider than necessary, then cut with a waterjet and finally corrected by hand in a trimming operation in order to get the final shape and to remove the shredded fibres and excess.

Despite this cutting and this trimming, the volume ratio of fibres and their de-framing at their ends are still difficult to control, which can lead to the presence of areas located at the level of the leading and trailing edges where the fibre volume ratio does not meet the specification and the mechanical properties are impacted.

At the level of the leading edge, this is a minor issue, as a metal shield is added as explained above and thus mechanically reinforces the leading edge. The weaving can then be done according to the final shape of the leading edge (“net shape”). To solve the problem at the level of the trailing edge, it is known to provide a fibrous preform configured to comprise a longer trailing edge at the mould exit, i.e. a trailing edge comprising a protuberance (usually an extrapolation at constant thickness from a certain position). This protuberance comprising the defaulting fibre volume ratio is then machined for removal.

Although this practice allows to obtain a trailing edge with the desired fibre volume ratio, it also results in a trailing edge with “square” protruding edges. A square trailing edge degrades the aerodynamic properties because recirculation areas can occur, which are referred to as “tail losses”. It is indeed preferable from a performance point of view to have rounded trailing edges as is the case in a conventional metal manufacture. This delta in aerodynamic performance reduces the benefit of the mass gain of the composite material vane compared to the metal alloy vane.

The trailing edge of the composite part can then be machined a second time to change from a square trailing edge to a round trailing edge by material removal, but this method adds an extra step in the vane manufacturing method and the difficulty of doing so can easily lead to non-conformities. However, at this near final step of manufacture, a non-conformity results in high cost scrap, which increases the average cost of the vanes.

In addition, it imposes geometric constraints on the trailing edge. Indeed, in order to carry out the machining operation in a single pass, a milling cutter with a single shape must be used, which results in a constant thickness of the trailing edge over the entire height of the blade and a shape that is not too twisted (or not too three-dimensional). An alternative would be to carry out this machining step in several passes and with several milling cutters, but this makes the machining operation considerably more complex and costly.

Furthermore, it is difficult to perform such a machining (simple or complex) after the disposal of a possible polyurethane erosion protection film and/or a possible film allowing for applying a surface treatment to the vane. In addition, in the case of a complex machining, i.e. without a single shaped milling cutter (trailing edge with variable thickness and/or complex shape), there is a risk of the machining tool becoming clogged with the polyurethane film.

Finally, there will be a potential mismatch between the machining step and very thin trailing edges allowing better performance (machining thin geometry can indeed be complex).

In particular, the present invention is intended to solve in particular some or all of the above problems.

### SUMMARY OF THE INVENTION

To this end, the invention proposes a composite vane for a turbomachine, in particular for aircraft, this vane comprising a blade comprising a pressure side and a suction side connected together by a leading edge and by a trailing edge, the blade being formed from a fibrous preform obtained by weaving fibres in three dimensions which is embedded in a polymeric matrix, the vane comprising a first metal shield extending over and along the leading edge of the blade, the vane further comprising at least one covering element extending over and along the trailing edge of the blade, characterised in that the covering element is made of a thermoplastic composite material and comprises at least one fibre fabric which is draped over at least one portion of the pressure side and of the suction side and which extends over and along the trailing edge and the leading edge of the blade, this fabric being interposed between the first shield and the leading edge and comprising fibres which are different from the fibres of the preform.

The covering element extending at the level of the trailing edge can cover and contain the loose/shredded fibres at the trailing edge with a lower fibre volume ratio and thus achieve the required mechanical properties and a more satisfactory aesthetic appearance. The invention also allows to obtain a rounded and in particular complex-shaped trailing edge, thus optimising the performance of the vane. Furthermore, the trailing edge is obtained in its final geometry directly at the exit of the mould, which avoids an additional step consisting in machining the composite material and thus avoids the disadvantages linked with this step presented previously, in particular an additional time and costs as well as constraints on the final shape of the trailing edge.

The vane according to the invention can be a stator vane or a rotor vane.

The vane according to the invention may comprise one or more of the following characteristics, taken alone or in combination with each other:
the vane comprises a second metal shield extending over and along the trailing edge of the blade, said fabric being interposed between the second shield and the trailing edge,
the second shield is made of a different metal alloy than that of the first shield;
   the second shield can be made of stainless steel or cobalt-nickel alloy (of the Inconel® type) for example;
   the second shield is made of a thermoplastic composite material;
the fabric is made of glass fibres;
the fabric extends over the entirety of the pressure side and of the suction side of the blade;
the fibres of the preform comprise carbon fibres;
the fabric comprises two adjacent edges which are located under the first shield or the second shield.

The present invention also relates to a method for manufacturing a vane as described above.

According to the invention, the manufacturing method comprises the steps of:
a) positioning the first shield and said at least one covering element on a fibrous preform of the blade,
b) placing the assembly thus formed into the cavity of a compaction mould,
c) closing the mould and compacting the assembly,
d) transferring the assembly into a polymerisation mould in order to polymerise the resin which is injected into the cavity of this mould or which is previously present on the fibres of the preform, so as to ensure the simultaneous securing of the first shield and of said at least one covering element with the blade.

The step a) of the method may also comprise positioning a second shield on the trailing edge of the blade. This second shield is then co-injected. Alternatively, it could be glued.

The step a) of the method may comprise spraying the fabric with a viscous spray to facilitate its adhesion to the preform.

### BRIEF DESCRIPTION OF THE FIGURES

Further characteristics and advantages of the invention will become apparent from the following detailed description, for the understanding of which reference is made to the attached drawings in which:

FIG. 1 is a schematic perspective view of a composite aircraft turbomachine vane;

FIG. 2 is a schematic perspective view of a variant of a composite aircraft turbomachine vane;

FIG. 3 is a schematic cross-sectional view of a blade with a first shield fitted to the leading edge and a second shield fitted to the trailing edge according to the invention;

FIGS. 4a, 4b and 4c are schematic cross-sectional views of a non-resin injected fibrous preform and intended to form a blade (FIG. 4a), of this same preform surrounded by a fibre fabric (FIG. 4b), and of this same preform surrounded by a fibre fabric with a first shield at the leading edge (FIG. 4c); and

FIG. 5 is a schematic cross-sectional view of a non-resin injected fibrous preform surrounded by a fibre fabric with a first shield at the leading edge and a second shield at the trailing edge according to the invention.

### DETAILED DESCRIPTION OF THE INVENTION

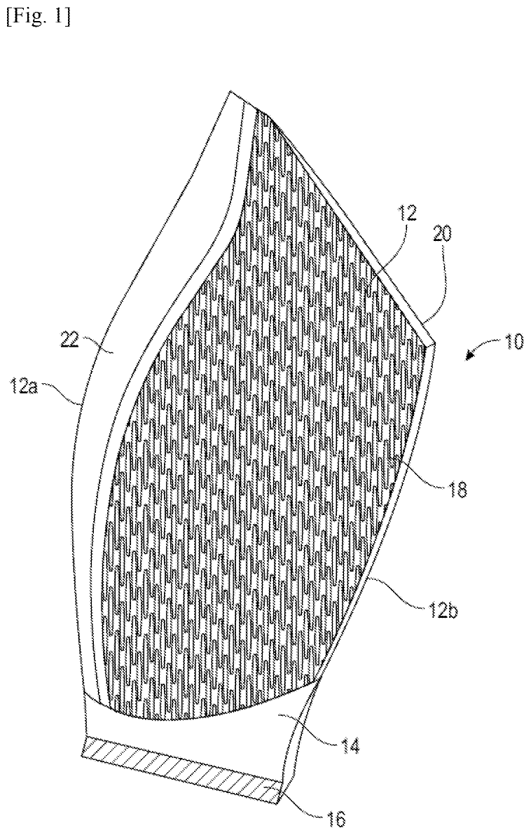

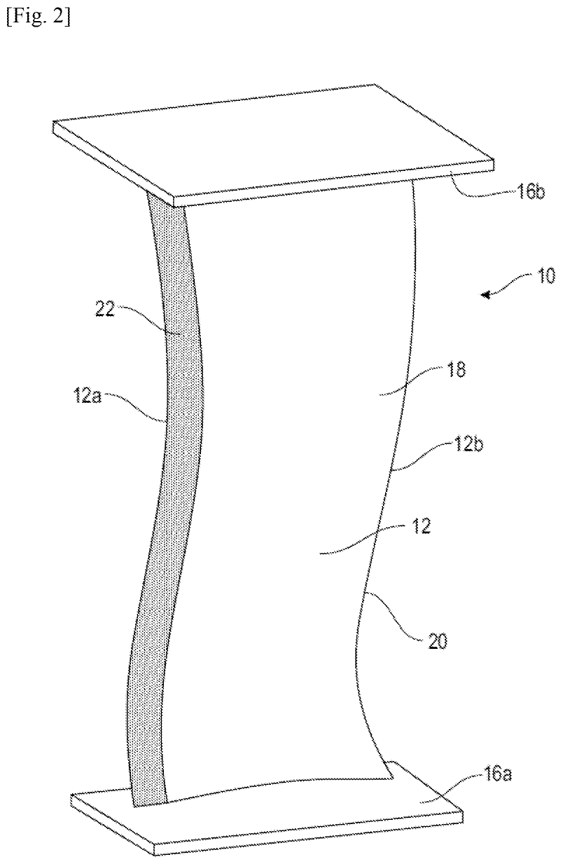

Reference is made firstly to FIGS. 1 and 2 which illustrate composite material vanes 10 for an aircraft turbomachine, in particular a turbofan. The vane 10 in FIG. 1 is a movable vane 10 (rotor vane), for example of a turbomachine fan. The vane 10 in FIG. 2 is a straightener vane 10 (stator vane) of a secondary duct of the turbomachine, referred to as OGV, whose initials refer to Outlet Guide Vane. However, the invention is applicable to any type of composite vane obtained from a three-dimensional woven preform.

In the case of FIG. 1, the composite vane 10 comprises a blade 12, connected by a stilt 14 to a root 16, which has for example a dovetail shape and is shaped to be engaged in a complementary shaped cell in a rotor disc, so as to retain the vane 10 on that disc.

In the case of FIG. 2, the composite vane 10 comprises a blade 12 extending between two platforms 16a, 16b.

The blade 12 of the vane 10 of FIGS. 1 and 2 comprises a leading edge 12a and a trailing edge 12b of the fluid, e.g., the gases, flowing into the turbomachine. The leading edge 12a is the edge through which the fluid first contacts the blade 12. The trailing edge 12b is the edge with which the fluid is last in contact with the blade 12. The blade 12 has a curved or twisted aerodynamic profile and comprises a pressure side 18 and a suction side 20 extending between the leading 12a and trailing 12b edges.

The blade 12 is made from a fibrous preform 2 embedded in a polymeric matrix and obtained by three-dimensional weaving of fibres, for example carbon.

The vane 10 also comprises a first metal shield 22 configured to reinforce and protect the leading edge 12a of the blade 12. The first shield 22 extends over and along the leading edge 12a of the blade 12. The first shield 22 is for example made of titanium or a nickel and cobalt based alloy. The first shield 22 is, for example, manufactured by electroplating which allows for more complex geometries. The choice between titanium or nickel and cobalt based alloy depends on the role of the vane 10. In the case of a rotor vane 10, titanium may be preferred. On the contrary, in the case of a stator vane 10, the nickel and cobalt based alloy can be preferred.

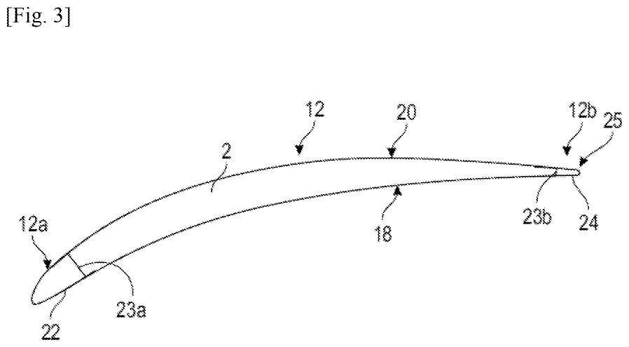

The invention proposes to add to the blade 12 at least one covering element 25 extending over and along the trailing edge 12b, as shown in FIGS. 3 to 5.

According to a first embodiment the covering element 25 comprises, for example, a second shield 24 extending over and along the trailing edge 12b of the blade 12, as shown in FIG. 3. This second shield 24 has less complex geometries and mechanical requirements than the first shield 22 of the leading edge 12a. This is because the trailing edge 12b is not located in the force path of the blade 12 and will undergo less mechanical stresses during operation. This advantage allows the second shield 24 to be made from a less expensive material, in particular a moulded thermoplastic composite material or a metal alloy, in particular different from the alloy used for the first shield 22. The second shield 24 is for example made of a metal alloy such as stainless steel, Inconel® (by additive manufacturing for example) or aluminium. The second shield 24 is in particular manufactured by electroplating. Furthermore, for a relatively straight trailing edge 12b, it is possible, for example, to manufacture the second shield 24 by bending a metal sheet, in particular steel, Inconel® or aluminium, the sheet metal bending method being less expensive than the electroplating method. Alternatively, it is possible to use the same material for the second shield 24 as for the first metal shield 22, particularly if a better mechanical strength is required.

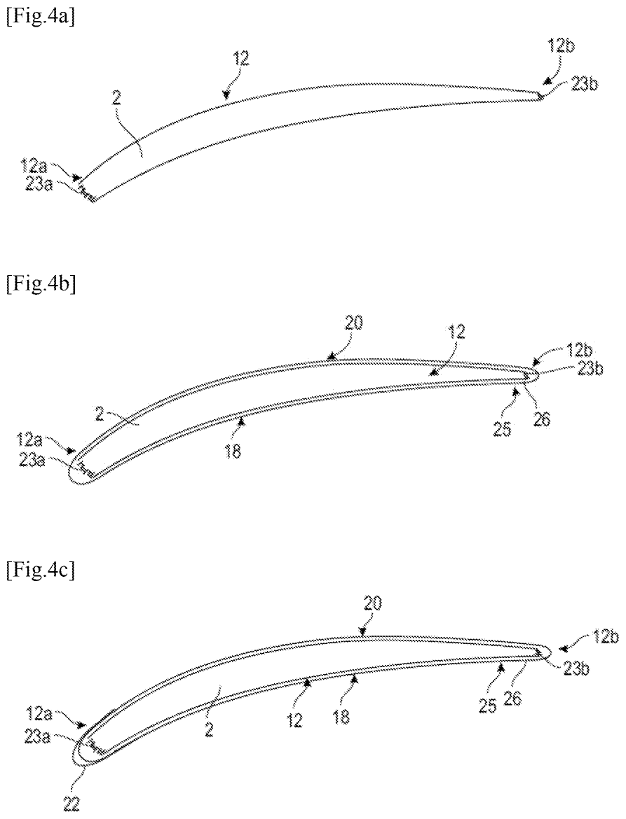

According to a second embodiment, the covering element 25 comprises, for example, at least one fibre fabric 26 as shown in FIGS. 4b and 4c, which is draped over the trailing edge 12b from at least one portion of the pressure side 18 to at least one portion of the suction side 20 and extends for example over the entirety of the pressure side 18 and of the suction side 20 of the blade 12. In the latter case, the fabric 26 completely surrounds the fibrous preform 2. The fibres of this fabric 26 are, for example, different from the fibres of the preform 2, and are in particular made of glass fibres.

The fibre fabric 26 is for example dry. It may then be necessary to add a viscous spray (tackifier) to the fibre fabric 26 to facilitate the adhesion of the latter to the fibrous preform 2.

In order to obtain a vane according to this embodiment, a fibrous form, not injected with resin, is in particular woven and then cut in order to obtain the fibrous preform 2, as shown in FIG. 4a. The loose ends of this preform 2, which will form the leading 12a and trailing 12b edges of the blade 12, respectively have generally shredded areas 23a, 23b whose fibre volume ratio is lower than that of the rest of the preform 2. This preform 2 is then surrounded by a fibre fabric 26, as shown in FIG. 4b, allowing to contain the shredded fibres of the shredded area 23b of the trailing edge 12b and for example of the shredded area 23a of the leading edge 12a, in particular so as to reinforce these areas 23a, 23b. The first metal shield 22 is then placed over and along the leading edge 12a, as shown in FIG. 4c. The fabric 26, covering the leading edge 12a of the blade 12, is then interposed between the leading edge 12a and the first shield 22. The next step is to place the assembly in a thermocompression mould so that the resin is injected and the assembly is heated so as to obtain the final part.

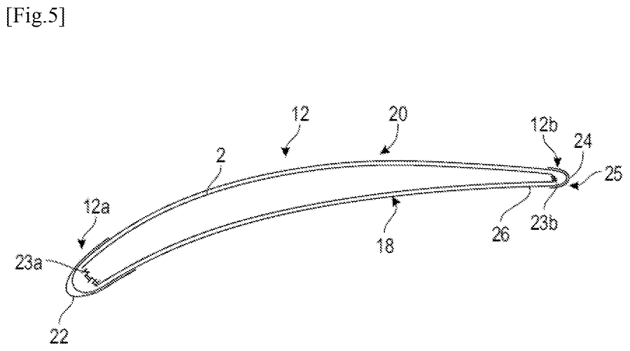

According to a third embodiment, the covering element comprises for example at least said second shield 24 on the trailing edge 12b of the blade 12 and at least said fabric 26, as shown in FIG. 5. This fabric 26 is then interposed between the trailing edge 12b and the second shield 24.

The blade 12 of this embodiment is made in a similar manner to that of the second embodiment except that the second shield 24 is added over and along the trailing edge 12b, for example just before or just after the addition of the first shield 22 over and along the leading edge 12a. The fabric 26, covering the leading edge 12a of the blade 12, is then interposed between the leading edge 12a and the first shield 22 and between the trailing edge 12b and the second shield.

Thus, several arrangements of the fibre fabric 26 on the blade 12 are possible, depending on the chosen embodiment, and in particular the following:
The fibre fabric 26 does not completely surround the blade 12. In this case, the fibre fabric 26 starts in particular on a rear segment of the suction side 20, passes around the trailing edge 12b and preferably ends on a rear segment of the pressure side 18.
The fibre fabric 26 completely surrounds the blade 12 and there is only the first shield 22 on the leading edge 12a (i.e. there is no second shield 24 on the trailing edge 12b). In this case, the two ends of the fibre fabric 26 are located in particular under the first shield 22.
The fibre fabric 26 completely surrounds the blade 12 and the first shield 22 as well as the second shield 24 are present. In this case, the two ends of the fibre fabric 26 are located in particular under the second shield 24 or alternatively under the first shield 22.

Whatever the embodiment of the invention, once the covering element 25 and the first shield 22 have been positioned, the next step is to place the assembly in a thermocompression mould so that the resin is injected and the assembly is heated in order to obtain the final part, i.e. the blade 12 of the vane 10, without performing any additional step.

Thus, thanks to the invention, the weaving of the trailing edge 12b can be carried out directly according to the final shape (“net shape”), i.e. of a rounded and possibly complex shape, thus avoiding the additional steps of machining, cutting by water jet or even adjustment of the prior art.

The addition of the fabric 26 around the blade 10 offers, in addition to improving the mechanical properties and the aesthetic aspect linked to the content of the shredded fibres of the shredded area 23b, to obtain a good surface condition beneficial with respect to the aerodynamic specification, in particular at the level of the roughness and the undulations of the surface. It also improves the mechanical qualities by protecting the blade against erosion and facilitates the repairs and the removal of the first shield 22 and of the second shield 24 when the latter is present, in particular because the fabric 26 minimises the pull-out of the composite located underneath during the peeling operation. For the same reason, this fabric 26 can also be easily changed when it is worn, for example by erosion.

The fabric 26 can be co-injected onto the preform, i.e. the connection between the fabric 26 and the composite blade will be made during the injection into the mould containing the fibrous preform, allowing to reduce the number of manufacturing operations, in particular painting, which in particular allows to increase the production rates and reduce the cost of the part.

The embodiments comprising the second shield 24 also have many advantages. In effect, the second shield 24 protects the potentially thin trailing edges 12b from impact and tool strikes during the manufacture, assembly and repair of the vane.

In addition, the properties of its material allow it do not reduce the service life of the part or the resistance to ultimate stresses and vibrations.

The second shield 24 may be glued or co-injected onto the trailing edge 12b, i.e. the connection between the second shield 24 and the composite blade will be carried out during the injection into the mould containing the fibre preform. This second solution is preferable because it allows to improve the final geometry of the vane, including very smooth transitions between composite and second shield, while reducing the risk of off-tolerances from the machining operation aiming to make the trailing edge round. The number of manufacturing operations is also reduced, including the one or several machining, as well as gluing and autoclaving, resulting in higher production rates and lower costs for the part.

The covering element 25, i.e. the fabric 26 and/or the second shield 24, thus allows to reduce the number of non-conformities found in the prior art methods comprising the machining step to remove the protuberance of the trailing edge and optionally the machining step to round the trailing edge 12b. In particular, the reduction in non-conformities allows in particular to reduce the treatment of the derogations and rejects. In addition, in low-volume production, initial errors leading to rejects have a high cost, which accentuates the financial advantage to the invention.

Thus, although the solution of the second shield 24 may at first sight seem more expensive than that of the machining of the prior art, the advantages raised above demonstrate that the average cost of the vane of the invention is conversely reduced, in particular in the case of low-volume production.

The invention also relates to a method for manufacturing a vane 10 as described above. Such a method comprises the steps of:
a) positioning the first shield 22 and said at least one covering element 25 on the fibrous preform 2 of the blade 12,
b) placing the assembly thus formed into the cavity of a compaction mould,
c) closing the mould and compacting the assembly; and
d) transferring the assembly into a polymerisation mould so as to polymerise the resin. The resin is either previously present on the fibres of the preform 2 so as to ensure the simultaneous securing of the first shield 22 and said at least one covering element 25 with the blade 12, or it is injected directly into the cavity of the compaction mould.

In both cases, this allows the covering element 25 to be co-injected with the fibrous preform 2 and results in the advantages mentioned above.

1. A composite vane for a turbomachine, in particular for an aircraft, this vane comprising a blade comprising a pressure side and a suction side connected together by a leading edge and by a trailing edge, the blade being formed from a fibrous preform obtained by weaving fibres in three dimensions which is embedded in a polymeric matrix, the vane comprising a first metal shield extending over and along the leading edge of the blade, the vane further comprising at least one covering element extending over and along the trailing edge of the blade, characterised in that the covering element is made of thermoplastic composite material and comprises at least one fibre fabric which is draped over at least one portion of the pressure side and of the suction side and which extends over and along the trailing edge and the leading edge of the blade, this fabric being interposed between the first shield and the leading edge and comprising fibres different from the fibres of the preform.

2. The vane according to claim 1, wherein it further comprises a second metal shield extending over and along the trailing edge of the blade, said fabric being interposed between the second shield and the trailing edge.

3. The vane according to claim 2, wherein the second shield is made of a different metal alloy than that of said first shield.

4. The vane according to claim 1, wherein the fabric is of glass fibres.

5. The vane according to claim 1, wherein the fabric extends over the entirety of the pressure side and of the suction side of the blade.

6. The vane according to claim 1, wherein the fibres of the preform comprise carbon fibres.

7. The vane according to claim 1, wherein the fabric comprises two adjacent edges which are located under the first shield or the second shield.

8. A method for manufacturing a vane according to claim 1, characterised in that it comprises the steps of:
a) positioning the first shield and said at least one covering element, and in particular said fabric, on a fibrous preform of the blade,
b) placing the assembly thus formed into the cavity of a compaction mould, and
c) closing the mould and compacting the assembly,
d) transferring the assembly into a polymerisation mould in order to polymerise the resin which is injected into the cavity of this mould or which is previously present on the fibres of the preform, so as to ensure the simultaneous securing of the first shield and of said at least one covering element with the blade.

9. The method according to claim 8, wherein, the vane being as defined in claim 2, the step a) also comprises positioning a second shield on the trailing edge of the blade.

10. The method according to claim 8, wherein the step a) comprises spraying a viscous spray onto the fabric to facilitate its adhesion to the preform.
